(19) United States
(12) Patent Application Publication
(10) Pub. No.: US 2019/0141009 A1
(43) Pub. Date: May 9, 2019

(54) SESSION MODERATOR FOR TURN-PATTERN TCP-PACKET RELAY WITH WEBSOCKET INSTANTIATION

(71) Applicant: General Electric Company, Schenectady, NY (US)

(72) Inventor: Chia CHANG, Los Angeles, CA (US)

(21) Appl. No.: 15/805,913

(22) Filed: Nov. 7, 2017

(51) Int. Cl. H04L 29/12; H04L 12/26; H04L 29/06; H04L 12/813; H04L 29/08

(52) U.S. Cl. CPC H04L 61/256; H04L 43/10; H04L 67/141; H04L 47/20; H04L 69/16

(57) ABSTRACT

A system for traversal around a network address translator, including a session moderator located within a configured network, the session moderator configured to receive a websocket connection request from a logical requestor located in a second private network, the websocket request identifying a logical receiver located in a third private network, send a first ping message to the logical requestor as confirmation, transmit a second ping message to the identified logical receiver, receive a second websocket connection request from the identified logical receiver, create respective websocket instantiations for each respective received websocket connection request, send session confirmation to the logical requester, then perform two-directional data flow binding between each of the respective websocket instantiations, receive one or more TCP resource packets from the identified logical receiver, and forward the one or more TCP resource packets to the logical requestor. A method and a non-transitory computer readable medium are also disclosed.

### BACKGROUND

TURN (Traversal Using Relays around NAT) is a protocol that enables a host device, located behind a network address translator (NAT), to control operation of an intermediate node acting as a communication relay. By implementing the TURN protocol, the host can exchange packets with its peers (e.g., other hosts) through the communication relay. Conventional implementations of the TURN protocol supports connection of a user behind a NAT to only a single peer.

For example, the TURN protocol can be used when a client wants to contact a peer computer, and both client and peer are each behind respective NATs. One drawback of being behind a NAT is that the NAT prevents various communications from passing beyond the NAT (e.g., multimedia applications, file sharing applications, etc.). Conventional TURN protocol implementation can allow the client to obtain IP addresses to relay data through a server connected to public Internet. However, TURN places an intensive demand on the resources of the TURN server. The conventional approach to implement TURN creates demand by relaying the entire communication through the server.

What is missing from the art is a two-way connectivity model that enables a general TCP connection that does not block inbound TCP traffic, so that a communication event between any two, or more, logical nodes can be sustained, where each node is run behind a respective NAT.

### TERMINOLOGY

Java Script Object Notation (JSON): a data interchange format.

Logical Receiver: a physical node that creates a websocket request, and/or establishes a TCP connection to a TCP resource, and performs protocol exchange by two-direction binding.

Logical Requester: a physical node that creates a websocket request, and/or establishes a TCP connection from a TCP requester, and performs protocol exchange by two-direction binding.

Protocol Exchange: conversion between protocols. For example, from TCP packet to Websocket, and vise-a-versa.

Physical Node: an allocated, functional memory stack that can accept a TCP handshake, and/or initiate a TCP handshake, and perform sub-processes.

Session Moderator: a physical node with ability to perform two-direction binding; control and/or monitor message exchange between a requester and a receiver; and allocate memory for the persistence and control of websocket connections.

Super Connection: a connection utilized for a variety of notifications (e.g., connection callback, auto-wakeup, etc.).

TCP/IP: Transmission Control Protocol/Internet Protocol.

TCP Resource: a physical node with complex computing process.

TCP Requester: a TCP node that initiates a TCP handshake to a logical requester.

Two-Direction Binding: a forwarding technique between from inbound transmission to outbound transmission; and/or from outbound transmission to inbound transmission.

User Datagram Protocol (UDP): alternative communication protocol to TCP.

Websocket: computer communication protocol providing full-duplex communication over a single TCP channel.

### BRIEF DESCRIPTION OF THE DRAWINGS

FIG. 1 depicts a system including a session moderator for TURN pattern TCP-packet relay in accordance with embodiments;

FIG. 2 depicts a system including a session moderator for TURN pattern TCP-packet relay in accordance with embodiments; and

FIG. 3 depicts a process for TURN pattern TCP-packet relay via a session moderator websocket in accordance with embodiments.

### DETAILED DESCRIPTION

Embodying systems and methods facilitate connectivity between resources of multiple NATs and/or network zones located behind the NAT or network zone. In accordance with embodiments, a session moderator can host websocket connections and facilitate connectivity within the session moderator between a source physical node (a requestor) and a target physical node.

In accordance with embodiments, a session moderator can simulate a general TCP socket connectivity. The session moderator can increase the scalability (e.g., four-way connectivity) among shared resources, establishing dynamic data flow, and centralizing overall security handshakes/protocol exchange.

Embodying systems and methods can be compatible with existing TCP/IP network settings, resulting in a cost reduction incurred by hardware/software configuration expenses compared to conventional implementations.

In accordance with embodiments, the session moderator can implement a “moderator session” protocol compatible with TCP Socket and Websocket composite-binding techniques, which conforms to the pattern described in Internet Engineering Task Force Request for Comments (IETF RFC) 5766.

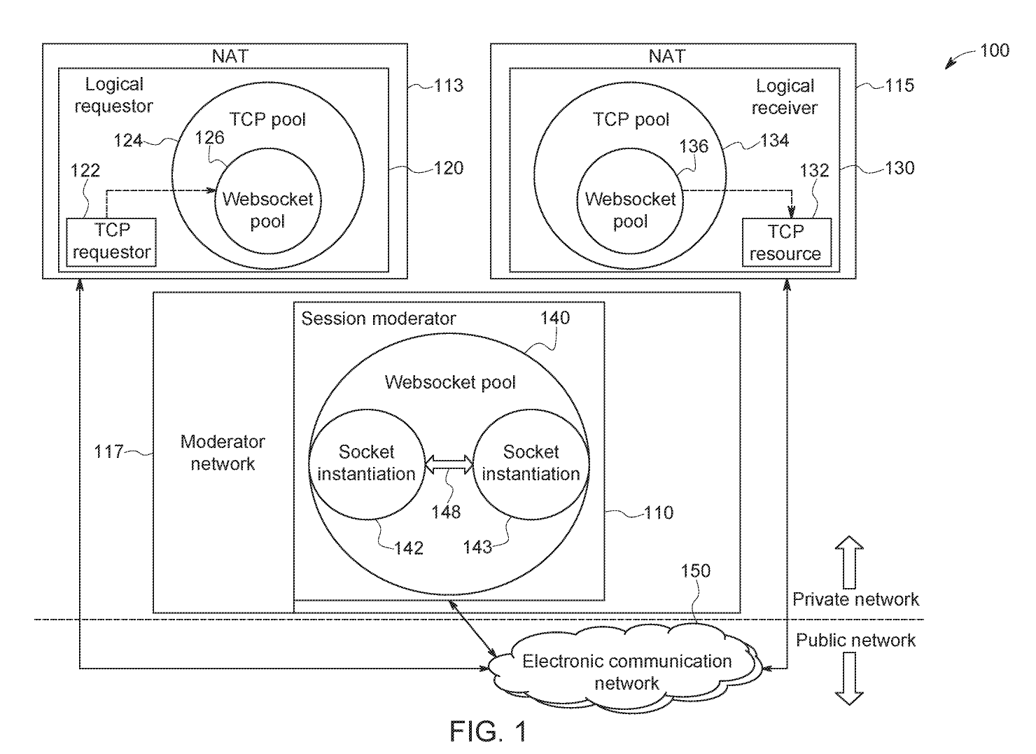

FIG. 1 depicts system 100 including session moderator 110 for TURN pattern TCP-packet relay in accordance with embodiments. Session moderator 110 is in communication with one or more NATs 113, 115, where each NAT is implemented in its own network. The session moderator itself can be located in moderator network 117. These devices are located in a private network setting. Each device is capable of communication with a public network, i.e. electronic communication network 150. The session moderator and each NAT can be within a network communication device—for example, a router. It should be recognized that embodying techniques and systems disclosed herein are not limited by the nature and/or type of private or public network.

As is readily understood by persons of skill in the art, each device (session moderator and NAT) can include a dedicated control processor, memory, and executable instructions which when executed by the control processor cause the control processor to perform embodying processes disclosed herein.

For purposes of discussion, FIG. 1 depicts two NATS. However, embodying systems are not so limited and systems with a greater number of NATs is within contemplation of this disclosure. NAT 113 is identified as including logical requestor 120 containing TCP requestor 122, TCP connection pool 124, and websocket connection pool 126. NAT 115 is identified as including logical receiver 130 containing TCP resource 132, TCP connection pool 134, and websocket connection pool 136. It should be readily understood that NAT 113 can act as a logical receiver, containing a TCP resource, and that NAT 115 can act as a logical requestor, containing TCP requestor.

Session moderator 110 includes websocket connection pool 140. Following a session moderator response to a websocket handshake request from a respective NAT, socket instantiation 142, 143 can be allocated and/or opened by the session moderator to support a full-duplex communication between the session moderator and the requesting NAT. Session moderator 110 supports communication between a logical requestor (e.g., NAT 113) and a logical receiver (e.g., NAT 115) by creating streaming exchange path 148 between the respective socket instantiations (e.g., socket instantiations 142, 143). In accordance with embodiments, communication and/or data transfer between logical requestor 120 and logical receiver 130 can be achieved within the session moderator via streaming exchange path 148.

In accordance with embodiments, moderator network 117 includes a network policy that supports session moderator 110 accepting traffic from both a logical requestor and a logical receiver, where each of NAT 113, NAT 115, and moderator network, 117 are private networks implementing their own respective specific network security, logic, and protocols.

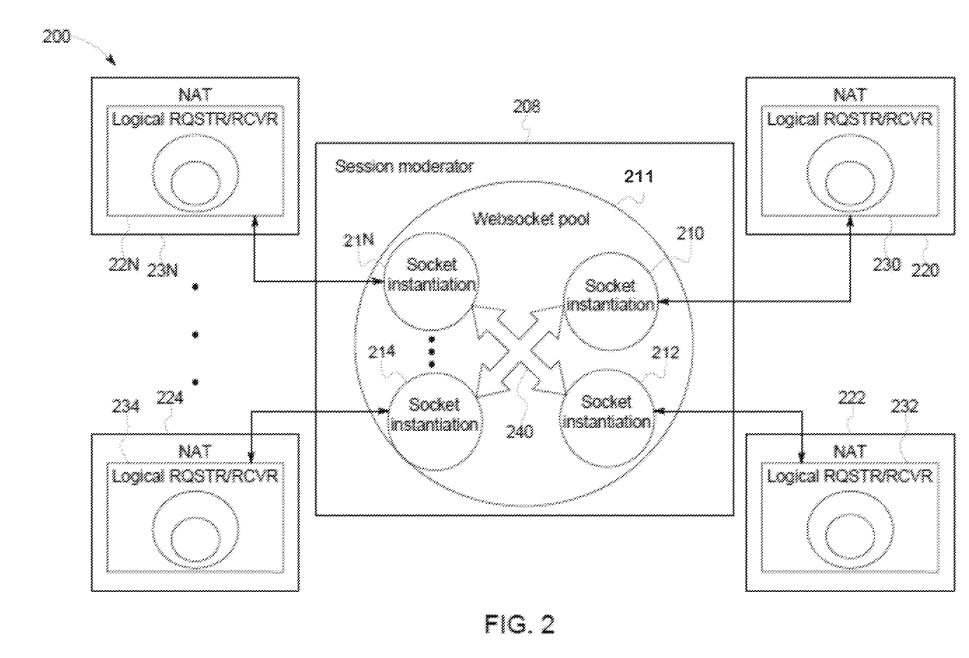

The embodying implementation illustrated in FIG. 1 establishes within the session moderator a streaming channel between two physical nodes (NAT 113, 115) located on separate private networks to create a two-way connectivity model. FIG. 2 depicts system 200 including session moderator 208 for TURN pattern TCP-packet relay in accordance with embodiments. The embodiment illustrated in FIG. 2 illustrates a four-way connectivity model with event driven communication. However, connectivity models having different participant quantities are within the contemplation of this disclosure.

Session moderator 208 includes websocket communication pool 211. FIG. 2 illustrates multiple NATs 220, 222, 224, . . . , 22N. In response to a websocket handshake from a respective NAT, session moderator allocates a corresponding socket instantiation (e.g., socket instantiation 210, 212, 214, . . . , 21N). Within each of NAT 220, 222, 224, . . . , 22N are respective logical receiver/requestor 230, 232, 234, . . . , 23N. In accordance with embodiments, a logical requestor can be either a logical receiver (when a particular resource is located in its same network), or a logical receiver can be a logical requestor (when a particular resource is located outside its same network). In accordance with embodiments, communication and/or data transfer between respective logical receiver/requestors can be achieved within the session moderator via streaming exchange path connection 240 between physical nodes of the private networks. In this manner resource located in one NAT can be transferred to a logical requestor in another NAT. In accordance with embodiments, the session moderator (acting as a logical gateway) can piggyback an event-driven Java message service as a software dependency for the data transmission.

Embodying systems and methods can facilitate communication between multiple physical nodes across different logical network zones (i.e., NATs). Embodying session moderators make this connectivity secure by controlling the overall handshakes/protocol exchanges with the different logical network zones, which can each be a separate private network.

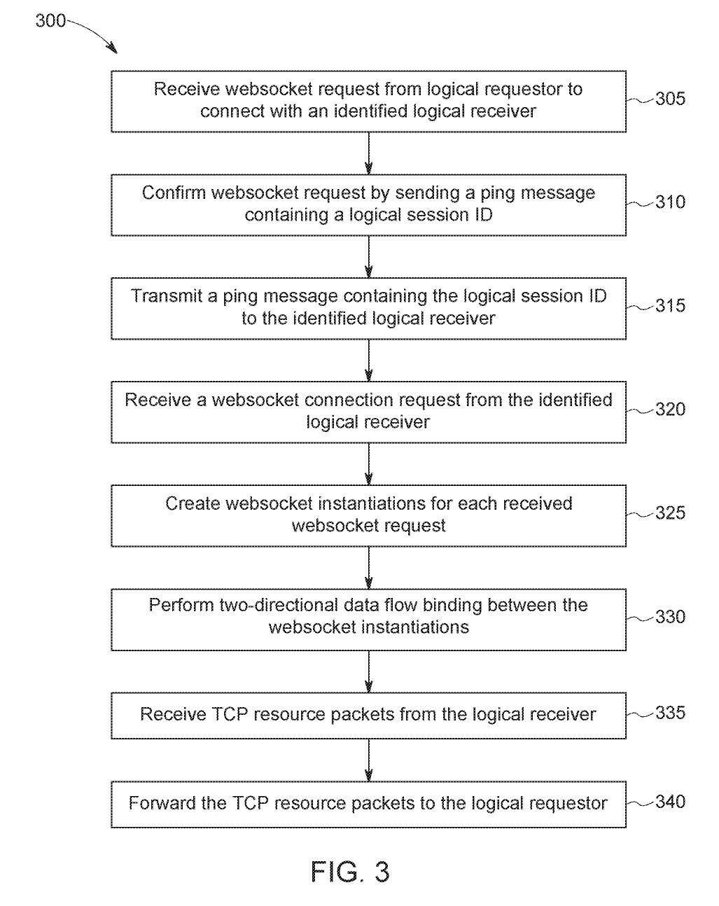

FIG. 3 depicts process 300 for TURN pattern TCP-packet relay via a session moderator websocket in accordance with embodiments. A logical requestor reacts to a TCP handshake from a TCP requestor by making a websocket request to a session moderator. Prior to sending the websocket request, the logical requestor establishes a superior connection with the session moderator by implementing a handshake protocol with the session moderator. The session moderator receives, step 305, the websocket request from the logical requestor. The websocket request includes an identification of the particular logical receiver to which the logical requestor is requesting connection. After sending the request, the logical requestor awaits a return notification from the session moderator.

The session moderator confirms, step 310, the websocket request by sending a first ping message containing a logical session ID back to the logical requestor. The session moderator also transmits, step 315, a second ping message containing the logical session ID to the identified logical receiver. The logical receiver receives the second ping message from the session moderator. The session moderator receives, step 320, from the identified logical receiver a websocket request sent in response to the second ping message.

The session moderator creates, step 325, respective websocket instantiations for each received websocket request. For example, FIG. 1 depicts two respective websocket instantiations 142, 143 within session moderator 110. FIG. 2 depicts four respective websocket instantiations 210, 212, 214, 21N within the session moderator.

The session moderator performs two-directional (e.g., full duplex) data flow binding, step 330, between the websocket instantiations to provide a streaming exchange path within the session moderator between a logical requestor and a logical receiver.

After the logical receiver establishes a connection with a TCP resource, the session moderator receives, step 335, from the logical receiver TCP resource packets via a protocol-exchange with two-directional binding. The session moderator forwards, step 340, the received TCP resource packets to the logical requestor via the streaming exchange path and the websocket instantiations within the session moderator.

In accordance with some implementations, the ping messages can have the following format:
{“msgType”:“..”,“bindId”:“..”,“sessionId”:“..”}

Where “bindId” is a logical ID to identify a pre-allocated logical slot of two-directional binding;

where “sessionId” is a logical ID to identify the two-direction binding;

where “msgType” is a description of the handshake status, with the following options:

“established”: when two-direction binding is established, a logical Id (session Id) got sent;

“standby”: when a handshake is initiated by the logical receiver, but no previous connection with the logical Id was found;

“request:acknowledge”: the requester confirms to the moderator that it received the handshake request;

“established:acknowledge”: signifies when the protocol exchange is successful; and

“request:received”: acknowledgment of receipt.

In accordance with embodiments, an embodying session moderator implementing embodying processes can bridge between multiple NATs and/or network zones. The session moderator can host websocket instantiations and a streaming exchange path that provides and facilitates the connectivity between the target and the source of physical nodes. The session moderator can increase scalability among shared resources, establish the dynamic data flow, and centralize overall security handshakes/protocol exchange. Additionally, an embodying session moderator can be configured to be compatible with any current, or future, TCP/IP network settings, which reduces the cost incurred by hardware/software configurations, reconfigurations, and updates.

In accordance with some embodiments, a computer program application stored in non-volatile memory or computer-readable medium (e.g., register memory, processor cache, RAM, ROM, hard drive, flash memory, CD ROM, magnetic media, etc.) may include code or executable instructions that when executed may instruct and/or cause a controller or processor to perform a method of TURN pattern TCP-packet relay within a session moderator that provides websocket socket instantiations and a streaming exchange path, as disclosed above.

The computer-readable medium may be a non-transitory computer-readable media including all forms and types of memory and all computer-readable media except for a transitory, propagating signal. In one implementation, the non-volatile memory or computer-readable medium may be external memory.

Although specific hardware and methods have been described herein, note that any number of other configurations may be provided in accordance with embodiments of the invention. Thus, while there have been shown, described, and pointed out fundamental novel features of the invention, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated. The invention is defined solely with regard to the claims appended hereto, and equivalents of the recitations therein.

We claim:

1. A system for traversal around a network address translator, the system comprising:
a session moderator located within a configured network, the session moderator operative to connect one of more logical requestor and receiver nodes, the session moderator including a control processor configured to access executable instructions, the executable instructions causing the session moderator to:
receive a first websocket connection request from a logical requestor located in a second private network, the websocket request identifying a logical receiver located in a third private network;
send a first ping message to the logical requestor as confirmation of receipt of the websocket request;
transmit a second ping message to the identified logical receiver;
receive a second websocket connection request from the identified logical receiver;
create respective websocket instantiations for each respective received websocket connection request;
perform two-directional data flow binding between each of the respective websocket instantiations;
receive one or more TCP resource packets from the identified logical receiver; and
forward the one or more TCP resource packets to the logical requestor.

2. The system of claim 1, including the first ping message and the second ping message containing a same logical session identifier.

3. The system of claim 1, including a streaming exchange path created by the two-directional data flow binding.

4. The system of claim 1, the session moderator configured to implement a network policy that supports acceptance of inter-network traffic from the second and the third private networks.

5. The system of claim 1, the session moderator configured to implement the two-directional data flow binding between three or more websocket instantiations to create a streaming exchange path between three or more private networks.

6. The system of claim 1, including the session moderator configured to create a secure connectivity environment by control of an overall handshake protocol exchange with the second and the third private networks.

7. A method of traversal around a network address translator, the method comprising:
receiving at a session moderator located within a first private network a first websocket connection request from a logical requestor located in a second private network, the websocket request identifying a logical receiver located in a third private network;
sending a first ping message to the logical requestor to confirm receipt of the websocket request;
transmitting a second ping message to the identified logical receiver;
receiving a second websocket connection request from the identified logical receiver;
creating respective websocket instantiations for each respective received websocket connection request;
performing two-directional data flow binding between each of the respective websocket instantiations;
receiving one or more TCP resource packets from the identified logical receiver; and
forwarding the one or more TCP resource packets to the logical requestor.

8. The method of claim 7, including in the first ping message and the second ping message the same logical session identifier.

9. The method of claim 7, including the two-directional data flow binding creating a streaming exchange path.

10. The method of claim 7, including implementing in the session moderator a network policy supporting acceptance of inter-network traffic from the second and the third private networks.

11. The method of claim 7, including implementing in the session moderator the two-directional data flow binding between three or more websocket instantiations to create a streaming exchange path between three or more private networks.

12. The method of claim 7, including controlling by the session moderator an overall handshake protocol exchange with the second and the third private networks to create a secure connectivity environment.

13. A non-transitory computer readable medium having stored thereon instructions which when executed by a control processor within a session moderator located in a configured network cause the session moderator to perform a method of traversal around a network address translator, the method comprising:
receiving at a session moderator located within a first private network a first websocket connection request from a logical requestor located in a second private network, the websocket request identifying a logical receiver located in a third private network;
sending a first ping message to the logical requestor to confirm receipt of the websocket request;
transmitting a second ping message to the identified logical receiver;
receiving a second websocket connection request from the identified logical receiver;
creating respective websocket instantiations for each respective received websocket connection request;
performing two-directional data flow binding between each of the respective websocket instantiations;
receiving one or more TCP resource packets from the identified logical receiver; and
forwarding the one or more TCP resource packets to the logical requestor.

14. The medium of claim 13 containing computer-readable instructions stored therein to cause the session moderator to perform the method, including in the first ping message and the second ping message the same logical session identifier.

15. The medium of claim 13 containing computer-readable instructions stored therein to cause the session moderator to perform the method, including the two-directional data flow binding creating a streaming exchange path.

16. The medium of claim 13 containing computer-readable instructions stored therein to cause the session moderator to perform the method, including implementing in the session moderator a network policy supporting acceptance of inter-network traffic from the second and the third private networks.

17. The medium of claim 13 containing computer-readable instructions stored therein to cause the session moderator to perform the method, including implementing in the session moderator the two-directional data flow binding between three or more websocket instantiations to create a streaming exchange path between three or more private networks.

18. The medium of claim 13 containing computer-readable instructions stored therein to cause the session moderator to perform the method, including controlling by the session moderator an overall handshake protocol exchange with the second and the third private networks to create a secure connectivity environment.
